(19) United States
(12) Patent Application Publication
(10) Pub. No.: US 2015/0124066 A1
(43) Pub. Date: May 7, 2015

(54) Wearable Decorative Ornament With Visual Display

(71) Applicants: Rima Ruhman, Galveston, TX (US); Eric Protzman, Silver Spring, MD (US)

(72) Inventors: Rima Ruhman, Galveston, TX (US); Eric Protzman, Silver Spring, MD (US)

(21) Appl. No.: 14/592,017

(22) Filed: Jan. 8, 2015

Related U.S. Application Data
(63) Continuation of application No. 13/133,399, filed on Oct. 31, 2011, now abandoned.
(60) Provisional application No. 61/120,693, filed on Dec. 8, 2008.

(51) Int. Cl. A44C 15/00; H04N 5/232; H04N 5/225

(52) U.S. Cl. CPC A44C 15/0015; H04N 5/2257; H04N 5/23293; A44C 15/001
USPC 348/61

(57) ABSTRACT

A wearable decorative ornament capable of photographing, storing and displaying an image, such that the image appears integral to the design of the decorative ornament, comprising a decorative case, an image-displaying device, an image capturing device, a communications port and a controller.

### BRIEF DESCRIPTION OF THE SEVERAL VIEWS OF THE DRAWINGS

FIG. 1 is a diagram of a wearable decorative ornament system as per an aspect of an embodiment of the present invention.

FIG. 2 is a diagram of a method for changing the visual appearance of a decorative ornament as per an aspect of an embodiment of the present invention.

FIG. 3 is a cross-section view of a decorative ornament as per an aspect of an embodiment of the present invention.

FIG. 4 is a front perspective view of a decorative ornament as per an aspect of an embodiment of the present invention.

FIG. 5 is a rear perspective view of a decorative ornament as per an aspect of an embodiment of the present invention.

FIG. 6 is a front perspective view of a decorative ornament as per an aspect of an embodiment of the present invention.

FIG. 7 is a front perspective view of a decorative ornament as per an aspect of an embodiment of the present invention.

FIG. 8 is a high level block diagram of an aspect of an embodiment of the present invention.

FIG. 9 is a block diagram of a Trinity/EPD interface used in an aspect of an embodiment of the present invention.

FIG. 10 is a level 1 device block diagram block of an aspect of an embodiment of the present invention.

FIG. 11 is a circuit-level schematic of an aspect of an embodiment of the present invention.

FIG. 12 is a timing diagram of a camera image sensor as per an aspect of an embodiment of the present invention.

FIG. 13 is a write timing diagram for a FIFO buffer as per an aspect of an embodiment of the present invention.

FIG. 14 is a read timing diagram for a FIFO buffer as per an aspect of an embodiment of the present invention.

FIG. 15 is a flow diagram as per an aspect of an embodiment of the present invention.

### DETAILED DESCRIPTION OF EMBODIMENTS

Aspects of the present invention are disclosed in the following description and related figures directed to specific embodiments of the invention. Those skilled in the art will recognize that alternate embodiments may be devised without departing from the spirit or the scope of the claims. Additionally, well-known elements of embodiments of the invention will not be described in detail or will be omitted so as not to obscure the relevant details.

In one embodiment of the invention, a wearable decorative ornament system may be provided. The ornament system may comprise a wearable decorative ornament, an external storage device, and a communications interface. The wearable decorative ornament may comprise a decorative case, at least one image-displaying device, a controller, a light-emitting device, and an image-capturing sensor. The image-displaying device may be a low power consumption device, such as, for example, an electrophoretic display or an electro-wetting display. In another embodiment of the invention, the wearable decorative ornament may comprise a decorative case, at least one image-displaying device, a controller, and an image-capturing sensor.

The wearable decorative ornament system may enable the user to incorporate a desired image or pattern into the wearable decorative ornament. For example, the user may desire to display an image or pattern on the wearable decorative ornament such that the image or pattern is coordinated with the user's wardrobe or environment. The user may capture the image or pattern via the image-capturing sensor, or transfer the image or pattern to the wearable decorative ornament using the communications interface. The image or pattern may then be displayed on the image-displaying device.

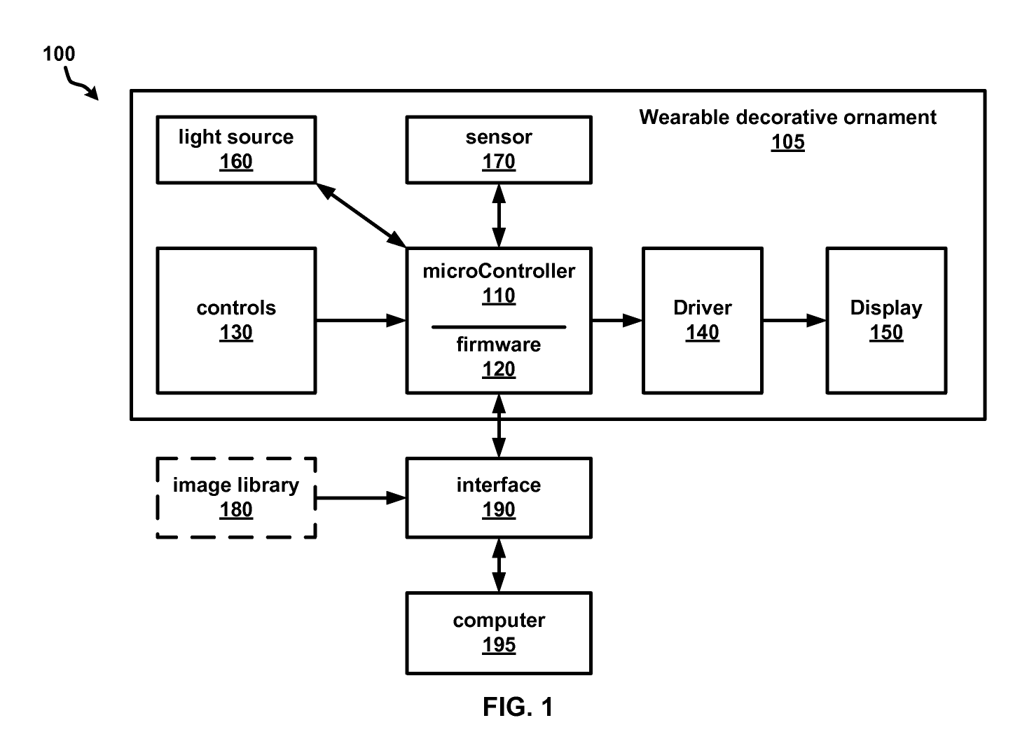

Turning to the accompanying figures, a wearable decorative ornament system is described. In one embodiment, system 100 may include a wearable decorative ornament 105, as shown in FIG. 1. Wearable decorative ornament 105 may include at least one controller 110. Controller 110 may include firmware 120. System 100 may also include computing device 195, which may communicate with decorative ornament 105 via communications interface 190. Computing device 195 may be, for example, a personal computer, a personal digital assistant, a portable phone, and may have user-operable software 185 operatively disposed therein. Communications interface 190 may be coupled to controller 110. Communications interface 190 may be a wired or wireless communication interface, and may conform to a known communications standard, such as, for example, Universal Serial Bus or Bluetooth.

User-operable software 185 may contain a computer-executable instruction set and communicate with decorative ornament 105 via communications interface 190 and with image library 180. Software 185 may also provide a user interface, allowing the user to configure decorative ornament 105 and image library 180 and access the digital images stored therein.

System 100 may also include an image library 180. Decorative ornament 105 may communicate with image library 180 via communications interface 190. Image library 180 may be located on any data storage device and contain one or more digital images that may be transferred to and displayed on image displaying device 150 of decorative ornament 105. The digital images may be of a common format such as JPEG, PNG or GIF. The digital images may also be of a proprietary format readable by decorative ornament 105 and associated software that may be executed on computing device 195.

Image library 180 may comprise a collection of digital images compiled by the user. For example, digital images may be photographed by the user via image capture sensor 170 and uploaded to image library 180 via communications interface 190. Digital images having a common format such as JPEG, PNG or GIF may also be uploaded by the user to image library 180 via user-operable software 185. In one embodiment, the digital images stored in image library 180 may be restricted to digital images provided or approved by a vendor of decorative ornament 105. For example, software 185 may access the vendor's server via a network such as the internet and download approved digital images from the server. The vendor may also provide digital images on a separate storage medium such as a CD-ROM, DVD-ROM, or flash memory device. The separate storage medium may then be accessed via software 185 and the digital images downloaded to library 180. The vendor may desire to store the approved digital images in a proprietary format accessible only by software 185 and controller 110 so as to prevent alteration by the user.

In one embodiment, controller 110 may be coupled to at least one image-capturing sensor 170 and at least one light-emitting device 160. Wearable decorative ornament 105 may include at least one set of user-operable controls 130 coupled to controller 110. Controller 110 may be an application-specific integrated circuit (ASIC), a reduced instruction set computer (RISC), or may have a full-instruction set. Controller 110 may be coupled to driver 140. Driver 140 may be coupled to image-displaying device 150.

User-operable controls 130 may comprise at least one control configured for tactile operation by the user. Controls 130 may include a means for operating image capturing sensor 170. Controls 130 may also include a means for controlling image displaying device 150, such as, for example, turning image displaying device 150 on or off, selecting among one of a plurality of images to be displayed on imaging device 150, or changing the orientation of the displayed image. Controls 130 may be a mechanical depressible button, a mechanical rotatable wheel, a touch-sensitive surface, a touch-sensitive surface with tactile feedback, or any other control known in the art. The user may also configure the operation of controls 130 using software 185 such that the controls are configured to the user's preference.

Image displaying device 150 may be a display device configured to display an image indefinitely without consuming electricity. For example, in one embodiment, image displaying device 150 may be an electrophoretic display. In another embodiment, image displaying device 150 may be an electro-wetting display. In yet another embodiment, image displaying device 150 may be an electrofluidic display. Image displaying device 150 may consume electricity only when changing the displayed image. Image displaying device 150 may be monochromatic or may include color filters for displaying color images.

Light-emitting device 160 may be any solid-state light emitting device, such as, for example, a light emitting diode, an organic light emitting diode, or a polymer light emitting diode. Optical conduit 350 may be constructed of any transparent material having high internal reflectivity, such as, for example, glass or a transparent polymer. Optical conduit 350 may also be constructed of at least one optical fiber.

Image capturing sensor 170 may be a solid-state light-detecting device, such as, for example, a charge-coupled device (CCD), or a complementary metal-oxide-semiconductor (CMOS) image sensor. Image capturing sensor 170 may be a monochrome sensor or may include color filters for capturing color images.

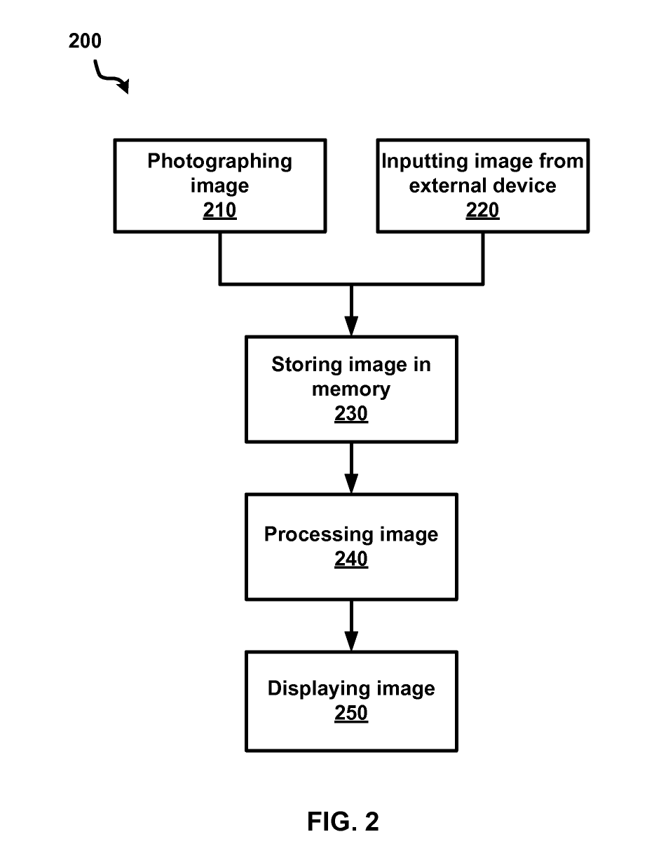

FIG. 2 shows a method 200 for capturing, processing and displaying an image according to one embodiment of the invention. According to FIG. 2, a user may input an image into decorative ornament 105 by photographing the desired image as shown at 210. This may be accomplished by positioning image capture sensor 170 proximate to the desired subject matter and operating controls 130. Upon operation of controls 130, light emitting device 160 may illuminate the desired subject matter and image capture sensor 170 may capture an image of the subject matter.

At 220, a user may input an image into decorative ornament 105 by inputting the image from an external device. The external device may be computer 195, image library 180, or any other device capable of communicating via interface 190 and storing images readable by controller 110.

At 230, the image input into decorative ornament 105 may then be stored in the memory of decorative ornament 105. At 240, the controller may process the image prior to displaying the image on image displaying device 150. For example, the controller may adjust the dimensions, proportions, resolution, color depth and other properties of the image to correspond to the dimensions and capabilities of image displaying device 150. At 250, the image may then be displayed on image displaying device 150.

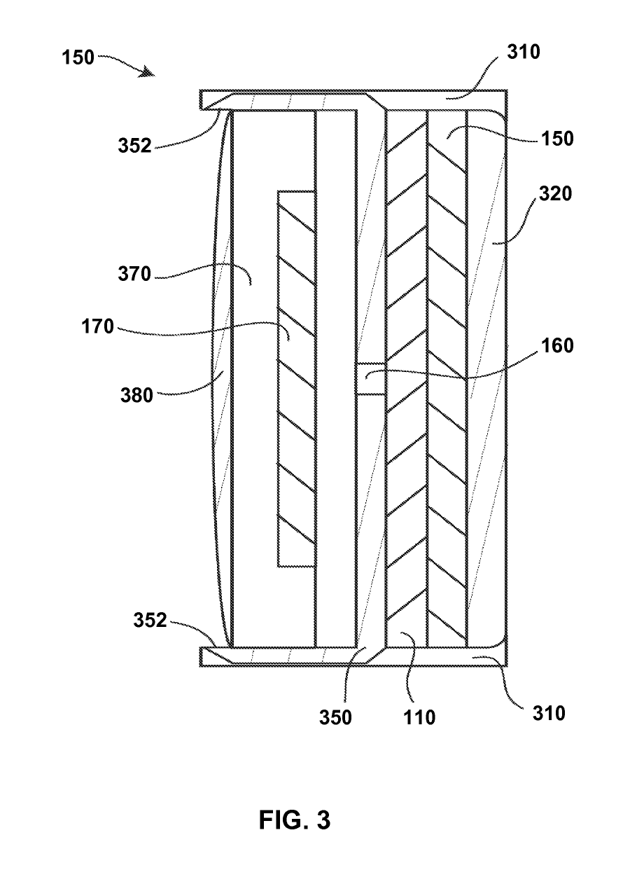

In one embodiment, as shown in FIG. 3, wearable decorative ornament 105 may include a decorative case 310. Wearable decorative ornament may also include, disposed within decorative case 310, a transparent protective layer 320, an image displaying device 150, a controller 110, a light-emitting device 160, an optical conduit 350, an image capturing sensor 170 and a lens 380, wherein image displaying device 150, light emitting device 160 and image capturing sensor 170 may be operatively coupled to controller 110. Lens 380 may have a focal length that may facilitate photographing subject matter located at short distances from lens 380, for example, between 0.5 to 2.0 inches. A vacuum or gas-filled space 370 may be disposed between lens 380 and image capturing sensor 170. The subject matter contained within the focal length of lens 380 may be illuminated by light emitting device 160 via optical conduit 350. Optical conduit 350 may be disposed within decorative case 310 and coupled to light emitting device 160. Light emitted by light emitting device 160 may be directed via optical conduit 350 to apertures 352. Apertures 352 may be located proximate to lens 380 to facilitate illumination of subject matter within the focal length of lens 380.

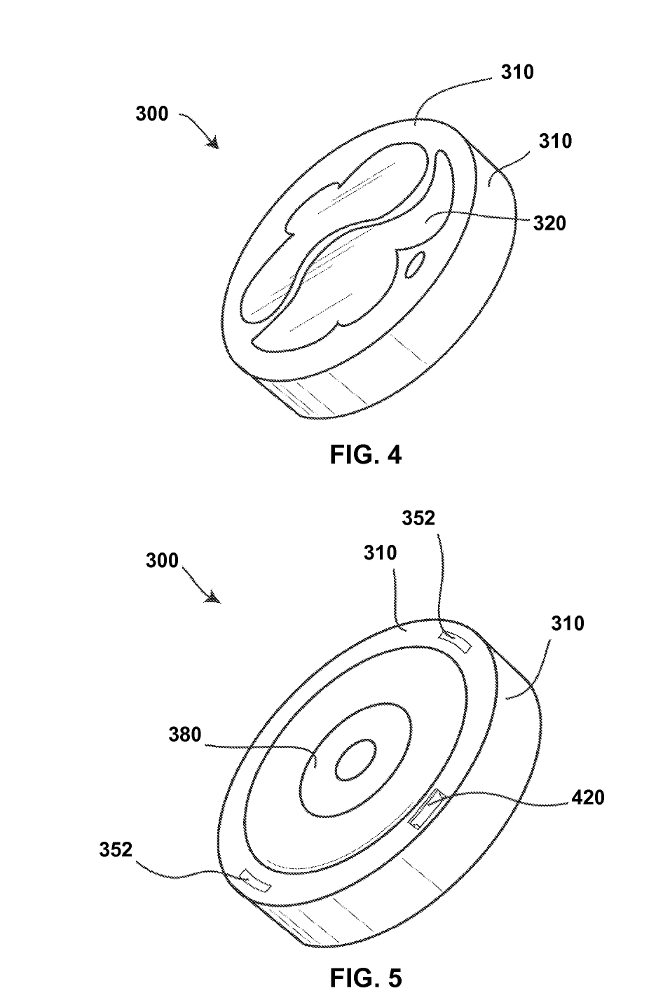

FIG. 4 shows a front view of an embodiment of the invention. The embodiment of the invention may have a decorative case 310. Decorative case 310 may have an ornamental design. Transparent protective layer 320 may be disposed within decorative case 310. Images displayed on image displaying device 150 may be viewed through transparent protective layer 320.

FIG. 5 shows a rear view of an embodiment of the invention. Disposed within decorative case 310 may be lens 380, optical conduit apertures 352 and communications port 510. Optical conduit apertures 352 may be positioned proximate to lens 380 such that light emitted via apertures 352 illuminates subject matter within the focal length of lens 380. Communications port 420 may conform to any communications standard used by personal computers, such as, for example, the Universal Serial Bus standard.

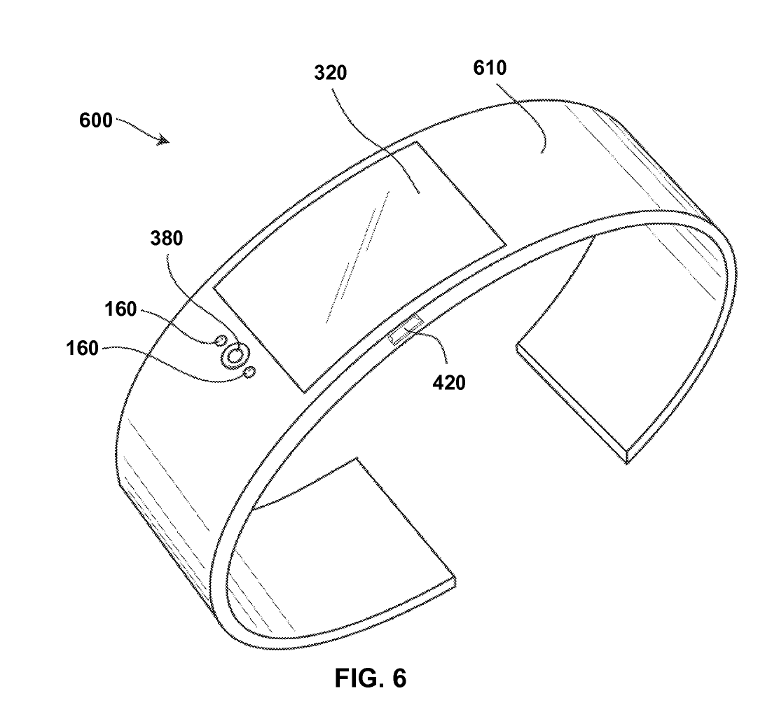

FIG. 6 shows a front view of another embodiment of the invention 600. The embodiment of the invention 600 may have a decorative case 610 having a shape similar to a bracelet or other article wearable directly on the body of the user. Transparent protective layer 320, lens 380, and at least one light emitting device 160 may be disposed on the same face of decorative case 610. Images displayed on image displaying device 150 may be viewed through transparent protective layer 320. Decorative case 610 may also include communications port 420, disposed such that communications port 410 does not interfere with the aesthetic design of decorative case 610.

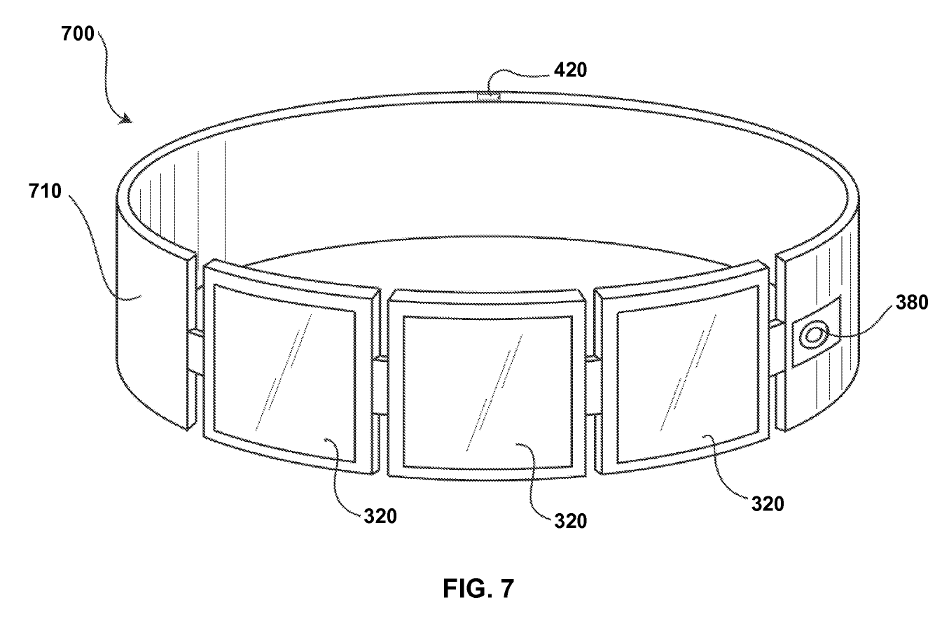

FIG. 7 shows a front view of another embodiment of the invention 600. The embodiment of the invention 700 may have a decorative case 710 having a shape similar to a bracelet or other article wearable directly on the body of the user. Decorative case 710 may have a plurality of transparent protective layers 320 disposed therein. Images displayed on image displaying device 150 may be viewed through transparent protective layers 320. Lens 380 may also be disposed on the same face of decorative case 710. Decorative case 710 may also include communications port 420, disposed such that communications port 420 does not interfere with the aesthetic design of decorative case 710.

Embodiments of the present invention may also be integrated onto clothing such as t-shirt, tie, belt buckle and so forth. With the press of a button, the user will be able to display whatever photo is taken for an indefinite amount of time. The primary premise of this embodiment is to display an image provided by an onboard camera module onto a display that requires no power to maintain once the image is set. This display could be shown on any particular article of clothing. Since energy consumption is a very important factor when dealing with portable electronics, an electronic paper display may be used in order to display a static image. As a result, the image doesn't consume any energy as it is displayed indefinitely. An onboard power supply may be used to provide the required energy to make this possible.

Some embodiments may receive input not only from the camera itself, but from a home computer just as well. This would provide a predefined image that would be able to be uploaded onto the display through the use of a USB port. Moreover, it would provide a temporary supply of power to the unit during connectivity. Bluetooth technology may also be used as an efficient method of transferring images to/from cell phone application(s). Additionally, the display may be configured to adjust automatically to the ambient level of surrounded lighting. This function could be implemented using photo sensors that measure the ambient light.

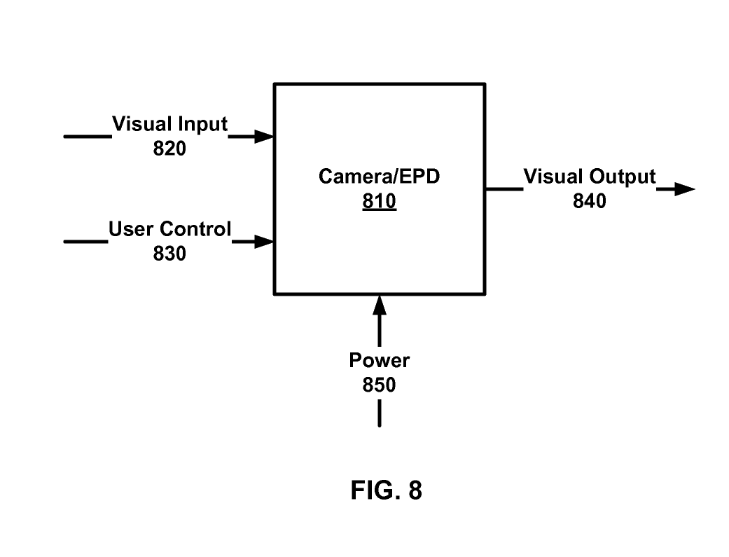

FIG. 8 shows a high level block diagram of a device 810 as per an aspect of an embodiment of the present invention. The device 810 can be broken down into a number of primary hardware components. As shown in FIG. 8, the primary inputs to the device 810 consist of three categories: active input 930 from the user to control the device in the form of buttons, input 820 in the form of light to be processed by the camera, and an input source 850 of electrical power capable of supporting the load of the system. All of these inputs may need to be harnessed and/or controlled in order to realize the specified operation of the device 810. A more detailed description of each of these processes is explained below. Equally significant in terms of the device 810 operation is the system output. In the context of a high level interpretation of the system, there ultimately exists a single output 840 in the form of the electronic paper display.

In order to achieve the basic goal of designing an embodiment of a portable device 810 capable of placing a camera-generated image onto an electronic paper display, several hardware elements may be required. The initial hardware elements include the camera and display. Less obvious components consisted of the intermediary components used the gather, store, format, and transfer the camera data to the display.

The electronic paper type display is an integral part of the design. Despite the fact that the technology is new and only very recently was adequately mature for use in the consumer market, designers are nonetheless confronted with a degree of choice in component selection. Currently the consumer market for electronic paper displays is dominated by two technologies, the eletrophoretic display (EPD) (available from E Ink Corporation of Cambridge, Mass.) and the cholesteric liquid crystal display (CHLCD). While both display technologies have similar attributes in terms of their ability to perform as an active matrix display as well as their capacity to indefinitely retain their image without power, there are a number of significant differences in performance. Electrophoretic display technology is currently used in high-resolution consumer electronic paper devices. These displays currently support a higher bit depth (current models support 4-bit grayscale images), demonstrate superior refresh rates to that of CHLCDs, and also feature considerably higher resolutions. Based on the results of research, it appears that EPDs are suited for integration with a relatively high performance digital media device such as a camera.

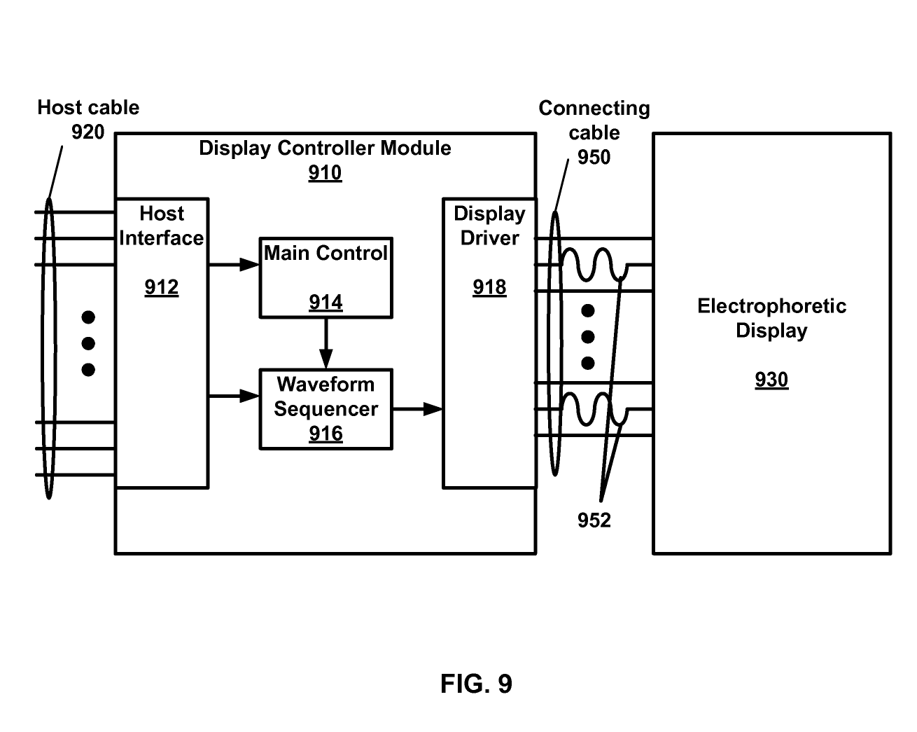

A primary developer and supplier of EPDs is a Taiwanese company called Prime View International. Their display operates with a protocol that works with a PVI embedded controller 910. FIG. 9 is a block diagram of the Trinity/EPD interface used in an aspect of an embodiment of the present invention. This device 910, called the Trinity controller, provides the output interface 918 to operate the display 930 (through connecting cable 950) as well as a parallel bi-directional data interface 912 for a third party host device (through cable 920). As shown in FIG. 9, the trinity 910 communicates with a host using a host interface 912 through a host cable 920. The host trinity controller 910 has a main control 914 and a waveform sequencer 916 that converts information from the host to a signal that drives the electrophoretic display 930 through a display driver 918 and connecting cable 950. The driving signal may include analog waveforms 952.

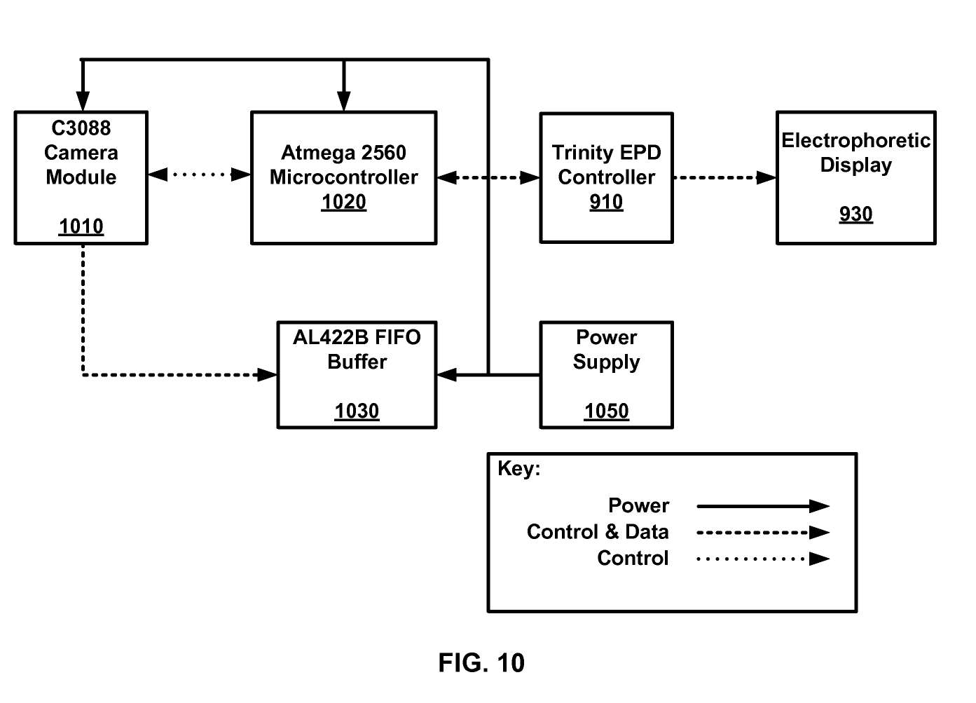

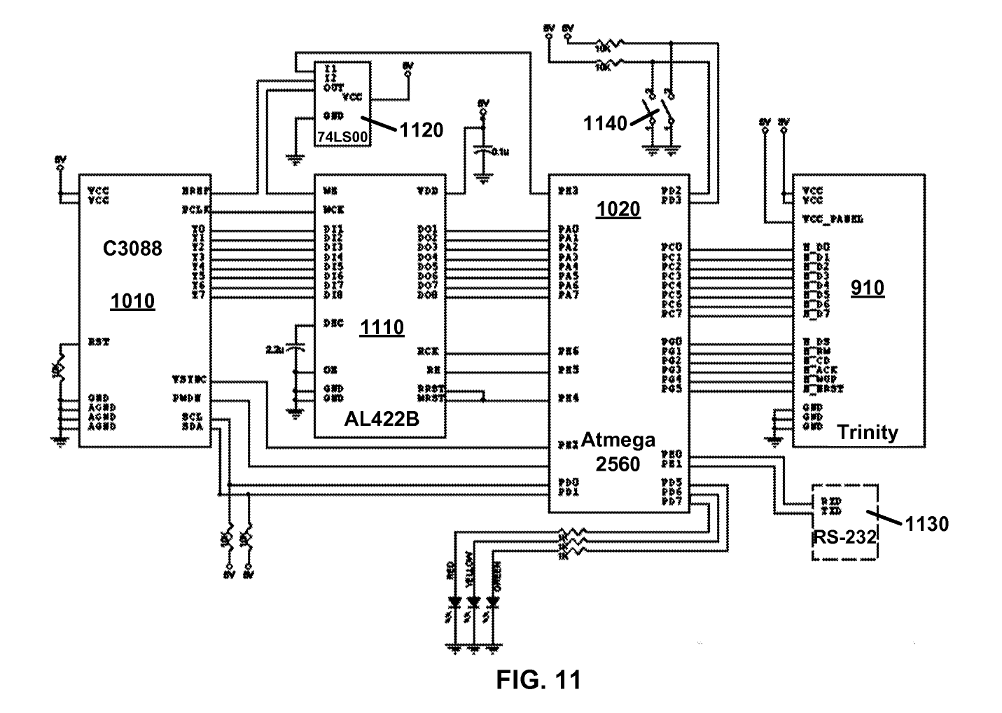

FIG. 10 is a level 1 device block diagram block of an aspect of an embodiment of the present invention. As shown, a second embedded intermediary processor 2560 may be used to format the image data to a form compatible with the Trinity controller 910. The choice of a camera 1010 may be affect the criteria of the microcontroller specifications.

The consumer market for image sensors is currently dominated by two competing technologies: the complementary metal oxide semiconductor (CMOS) and charge coupled device (CCD). While for many years the CCD has outperformed CMOS image sensors in terms of image quality, improvements in design and considerably cheaper manufacturing costs have seen a large growth in the prevalence of CMOS in the consumer market. CMOS image sensors which tend to be smaller that than comparable CCDs may be useful in compact applications. Omnivision of Santa Clara, Calif., a global manufacturer of CMOS image sensors may be used. One model in particular, the low voltage VGA-compatible OV6620 that operates at a relatively low clock speed and is capable of transferring image data across an 8-bit parallel interface proved to be a favorite among several low-end microcontroller projects such as the AVRcam and CMUcam. It was also discovered that a camera module called C3088 1010 was available featuring the OV6620 sensor in combination with an optical platform and header pin breakout circuit board. This may be a useful package for prototyping an embodiment of the present invention.

There are many different microcontrollers by numerous manufacturers that may be used in constructing embodiments. One possible microcontroller is from the Atmel's line of 8-bit AVR microcontrollers. The AVR has low power consumption, operating voltages equal to that of the OV6620 image sensor, a flexible operating speed, and a selection of potentially useful internal peripherals. Specifically, the AVR ATmega2560 1020 may be used. This 100-pin microcontroller has a multitude of general purpose input/output pins ideal for the demands of multi-bus parallel communication. Also useful are peripherals to handle RS-232 serial communication for data transfer and debugging with a personal computer and I2C communication to modify camera settings. These available features on the device may be suitable for the role of intermediary host device.

For several reasons, one may decide to select a different microcontroller fro other embodiments. For example, a low power 8-bit microcontroller may have a limited clock speed which is difficult to apply to real-time applications such as steaming pixel data. Additionally, low power microcontroller memory may be limited. While the ATmega2560 1020 contains a comparatively impressive 8 kilobytes of internal SRAM, it does not contain nearly enough memory to hold an 8-bit grayscale image of approximately 93 kilobytes. As a result, the designer is faced with a dilemma with two apparent solutions: either slow down the speed of the camera and process the image frame in a piecemeal fashion, or introduce more hardware into the system in the form of external memory. Another solution is to use a FIFO buffer 1030 such as the AL422B 3-megabit FIFO buffer. The FIFO buffer 1030 may enable the capture of an entire image frame at one time without sacrificing speed performance.

With the basic hardware components of the embodiment are introduced, a mid-level overview of the interactions between the devices will be discussed. Referring to FIG. 10 for a mid-level component diagram of this specific embodiment. As can be seen in the diagram, the majority of the interactions between the components are bi-directional for both control information as well as data. The embodiment may be broken down into two primary processes: the interactions between the camera 1010 and the microcontroller 1020, and the interactions between the microcontroller 1020 and the display controller 910. These two processes (reading and writing) comprise of the two main behavior states of the system with the latter state successively following the former.

An important portion of the embodiment's design may be in terms of the interface between software and hardware consisting of the write sequence, where an entire frame from the image sensor 1010 is captured and stored by the microcontroller 1020 for referencing and formatting. As mentioned earlier, this may be due to insufficient memory within the microcontroller 1020 itself as well as the fact that the image sensor 1010 may operate at a speed slightly higher than that of the microcontroller 1020. These problems may be solved with the inclusion of a FIFO buffer 1030 in order to resolve both issues. As can be seen in the diagram control signals interconnect the camera 1010, the FIFO buffer 1030, and microcontroller 1020. These interactions as well as how the timing issue may be resolved will be discussed later. More straightforward is how the memory issue may be resolved. It may also be apparent in the diagram that there exists a data transfer bus between the FIFO buffer 1030 and both the camera 1010 and the microcontroller 1020. This is because the FIFO 1030 may be capable of storing up to 3 megabits within it memory and is thus able to store an entire image frame. Following the capture of an image, the FIFO 1030 may transfer the data to the microcontroller 1020.

Considerably more straightforward is the interaction between the microcontroller 1020 and the display controller 910. During the write state, this portion of the system idles as the image from the camera 1010 is loaded into the FIFO buffer 1030. Following the completion of the FIFO loading sequence, the microcontroller 1020 may signal the end of the write state and the beginning of the read state. During this period, the microcontroller 1020 may undergo the process of reading pixels from the FIFO buffer 1030 and formatting them into an arrangement readable by the Trinity controller 910. The formatted data may be subsequently transferred to the display controller 910 using a protocol understood by the Trinity device 910. The image buffer of the display controller 910 may be filled by microcontroller 1020 until the pixel data transfer process is complete and the image is subsequently shown on the EPD 930. The details of the read sequence and write sequence will be explained in the following section.

With the components and their high-level interactions introduced, the low-level operation of the device can now be explained. FIG. 11 is a circuit-level schematic of an aspect of an embodiment of the present invention. The primary devices introduced above are clearly visible. Other components consist of a 74LS00 NAND gate 1120 integrated circuit and two single pole, single throw on/off switches 1140. Additionally a generic RS-232 module 1130 may be included.

As mentioned in the previous section, the active operation of the embodiment may be categorized as two basic states: read and write. During the read state, the system gathers information from the camera 1010 and stores it into temporary memory. This procedure can further be disassembled into several sub-processes that are comprised of interactions between the camera module 1010, the microcontroller 1020, and the FIFO buffer 1030. During the read state, the frame data temporarily stored on the FIFO buffer 1030 may be read and formatted by the microcontroller 1020 and subsequently sent to the Trinity controller 910 to be displayed on the EPD 930. This can similarly be dissected into several sub-processes consisting of interactions between the microcontroller 1020, the FIFO buffer 1030, the Trinity controller 910, and EPD 930.

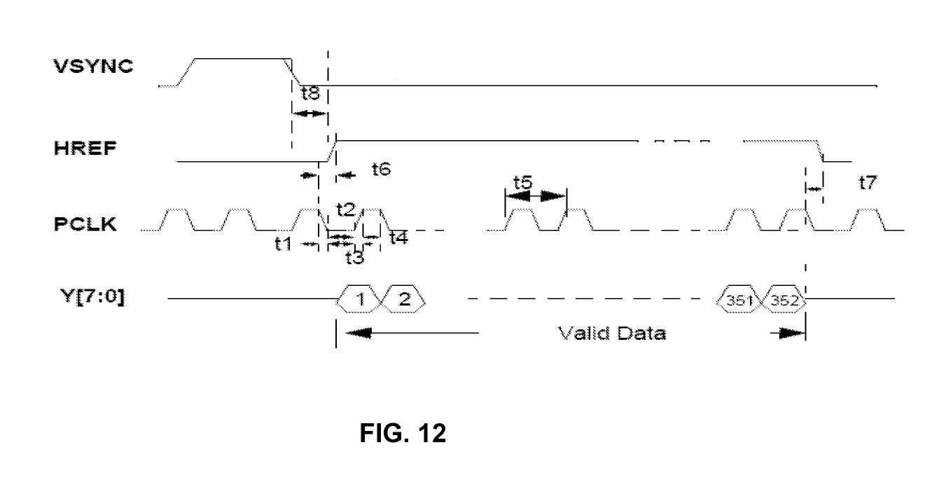

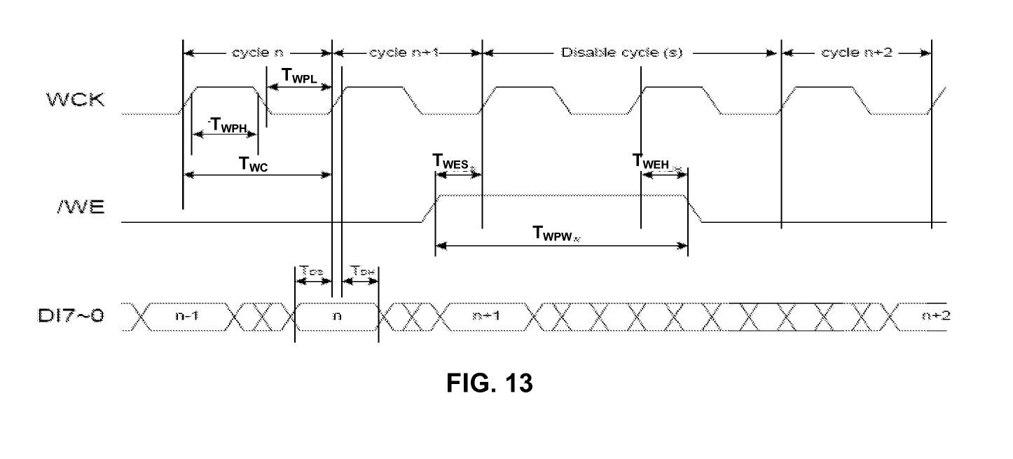

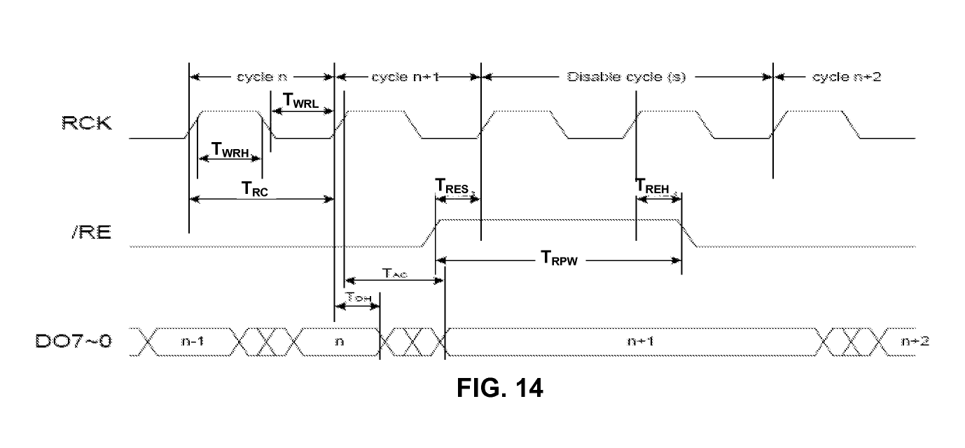

The image frame write process may be the most time-sensitive portion of the device operation. FIG. 12 is a timing diagram for camera image sensor 1010, FIG. 13 is a write timing diagram for FIFO buffer 1030 and FIG. 14 is a read timing diagram for FIFO buffer 1030. The relevant timing lines associated with the camera 1010 are the vertical synchronization (VSYNC), horizontal reference (HREF), and pixel clock (PCLK) signals. The VSYNC signal is responsible for indicating the beginning of an image frame. HREF signals the beginning of a new line of pixel data. PCLK reveals when a new pixel is available on the data bus. Following the press of a button by the user, the write sequence begins with an examination of VSYNC by the microcontroller 1020. As can be seen in FIG. 12, VSYNC pulses before image data for a new frame exists on the Y bus. This pulse and the subsequent delay before the beginning of image data (t8 in the diagram) is the sole camera control signal capable of being processed by the microcontroller 1020 due to the constraint of its slower clock speed relative to the camera 1010. The remaining signals VSYNC and HREF are handled using hardware in the form of combinational logic as well as the FIFO buffer control lines. This enables the entirety of the image data to be stored in the FIFO buffer 1030, thus eliminating the need for the microcontroller 1020 to keep track of all camera control signals.

The design of the combinational logic block may be implemented specifically to account for the HREF signal which may be important for obtaining a proper image frame. As inputs, the logic block observes the state of both the image frame (affected by VSYNC) and HREF. The output of the logic block controls the write enable line (WE) of FIFO buffer 1030. Construction of a truth table shows that requirements may be satisfied by a 2-input NAND gate 1120. Finally, the PCLK line is interfaced directly with the FIFO buffer 1030 write clock (WCK). As shown in FIG. 13, a single pixel is gathered from the camera/buffer data bus on every rising edge of the write clock. All timing signals shown in the diagram are more than an order of magnitude faster than the speed of PCLK.

Following the completion of the write sequence for the system, the less time-sensitive portion of system operation begins. During the read sequence shown in FIG. 14, the pixel data previously written to the FIFO buffer 1030 may be retrieved by microcontroller 1020 and formatted to a configuration acceptable by the Trinity Controller 910. The read operation for the FIFO buffer 1030 is similar to that of the previous write operation as shown in FIG. 14. This time however, the FIFO read clock (RCK) and read enable (RE) may be directly controlled by the microcontroller 1020 and thus timing is not an issue. The pixel formatting process may include using a lookup table that takes as an input an 8-bit camera pixel, calculates thresholds based on the dynamic range of the image, and returns a 2-bit pixel compatible with the bit depth of the Trinity controller 910. Pixels may be processed and transferred to the Trinity controller 910 in groups of four.

The final portion of device operation consists of the power supply 1050. This component may be configured to minimize the variation of operating voltages among components for the purpose of reducing the amount of voltage regulation circuitry needed to implement the device. While the operating voltages are equivalent for the camera module 1010, FIFO buffer 1030, and microcontroller 1020, the Trinity controller 910 differs. For the Trinity controller 910, there exist two differing voltage inputs: 5 volts (similar to the other devices) to drive the EPD 930 and 3 volts to power the processor. As a result, it may be necessary to implement two voltage regulators, both a 5 volt and 3 volt output device.

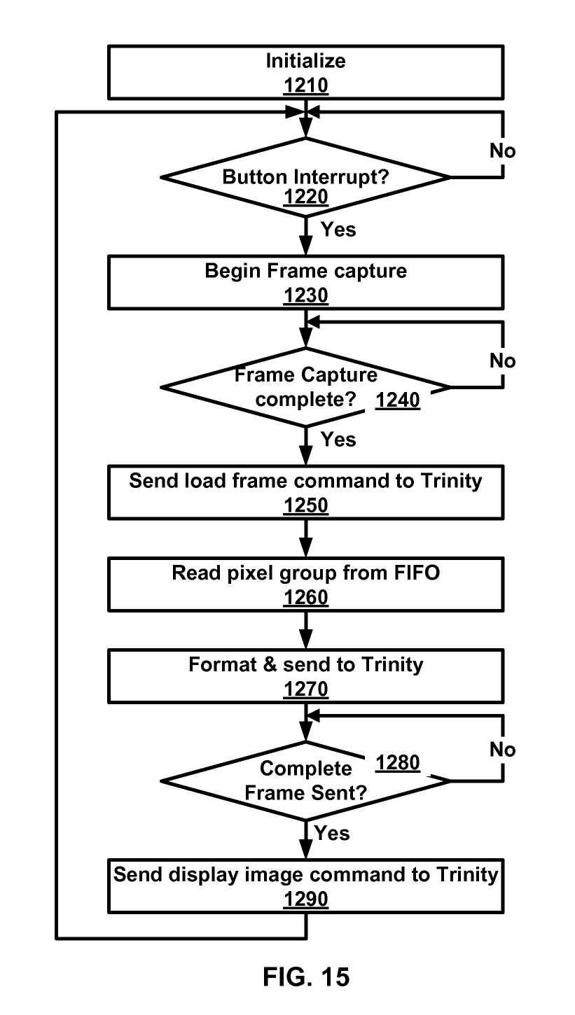

The software design of the microcontroller 1020 may be implemented using an interrupt-based model for state transitions for the purposes of efficiency and also to allow for the implementation of low power modes among the various devices in the system. FIG. 15 is a flow diagram of an embodiment microcontroller code. As can be seen in FIG. 15, the microcontroller 1020 begins with an initialization procedure 1210 to initialize peripherals relevant to the operation of the device. These may include a UART and I2C peripherals for debugging, the configuration of the ports for button interrupts, and the delegation of pins for communication with the FIFO buffer 1030, camera 1010 and Trinity controller 910. Following the initialization procedure, the microcontroller idles in a low power state until a button interrupt occurs at 1220. Following the push of a button, the frame capture sequence (1230) beings as described in the previous section. Following the completion of the capture of an entire frame (1240), a frame command is set to the Trinity controller (1250), the frame data is read from the buffer (1260), formatted and transferred to the Trinity (1260) in 4-pixel fragments until an entire frame is transferred (1280). Following its completion of the frame transfer (1290), the microcontroller returns to its idle state to await another button interrupt.

In this specification, “a” and “an” and similar phrases are to be interpreted as “at least one” and “one or more.”

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example embodiments related to jewelry. However, one skilled in the art will recognize that variations to embodiments of the invention can be made by those skilled in the art without departing from the scope of the invention as defined by the claims. For example, the decorative case could be configured an item of clothing rather than jewelry.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Many of the elements described in the disclosed embodiments may be implemented as modules. A module is defined here as an isolatable element that performs a defined function and has a defined interface to other elements. The modules described in this disclosure may be implemented in hardware, software, firmware, wetware (i.e hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A wearable decorative ornament capable of photographing, storing and displaying an ornamental image, such that the ornamental image appears integral to the design of the decorative ornament, comprising:
a) an individual decorative ornamental case, attachable to a person;
b) at least one image-displaying device disposed within and integral with the case, said image-displaying device configured to:
i) setup the ornamental image using electrical power; and
ii) display the ornamental image without electrical power;
c) at least one memory device disposed within and integral with the case for storing ornamental image data;
d) at least one image capturing device disposed within and integral with the case for photographing an external image of a pattern coordinated with the person's wardrobe;
e) a communications port for receiving image data from an external electronic device; and
f) a controller disposed within and integral with the case coupled to the image capturing device, image displaying device, light-emitting device, communications port, and memory device; and
wherein the ornamental image is the pattern coordinated with the person's wardrobe.

2. The wearable decorative ornament of claim 1, further comprising an optical lens disposed adjacent to the image capturing device.

3. The wearable decorative ornament of claim 1, further comprising a light-emitting device disposed within the case for illuminating the focal area of the image capturing device.

4. The wearable decorative ornament of claim 1, wherein the image-displaying device is an electrophoretic display.

5. The wearable decorative ornament of claim 1, wherein the image-displaying device is an electro-wetting display.

6. The wearable decorative ornament of claim 1, wherein the image-displaying device is an electrofluidic display.

7. The wearable decorative ornament of claim 1, wherein the communications port is compliant with the Universal Serial Bus standard.

8. The wearable decorative ornament of claim 1, wherein the data storage device is a flash memory EEPROM device.

9. The wearable decorative ornament of claim 1, wherein the decorative ornament is a wrist strap.

10. The decorative ornament of claim 1, wherein the decorative ornament is a brooch.

11. A method for changing the visual appearance of an individual wearable decorative ornament, comprising:
a) obtaining an ornamental digital image of a pattern coordinated with the individual's wardrobe from at least one image capturing device disposed within and integral with the individual wearable decorative ornament;
b) storing the ornamental digital image in a memory device disposed within the decorative ornament using electrical power; and
c) displaying the ornamental digital image on an image-displaying device disposed within and integral with the decorative ornament, without electrical power; and
wherein the individual wearable decorative ornament displaying the ornamental digital image is configured to be part of the individual's wardrobe.

12. The method of claim 11, further comprising obtaining the ornamental digital image via an image capture device disposed within the wearable accessory.

13. The method of claim 11, wherein the focal area of the image capture device is illuminated by a light-emitting device.

14. The method of claim 11, wherein the light-emitting device is at least one light-emitting diode disposed within the wearable accessory.

15. The method of claim 11, further comprising obtaining the digital image via a communications port for receiving data disposed within the accessory.

16. The method of claim 15, wherein the communications port is compliant with the Universal Serial Bus standard.

17. The method of claim 11, wherein the memory device is a flash memory EEPROM device.

18. The method of claim 11, wherein the image-displaying device is an electrophoretic display.

19. The method of claim 11, wherein the image-displaying device is an electro-wetting display.

20. The method of claim 11, wherein the image-displaying device is an electrofluidic display.
